(19) United States
(12) Patent Application Publication
(10) Pub. No.: US 2002/0069183 A1
(43) Pub. Date: Jun. 6, 2002

(54) Method and data processing system for the knowledge-based advising, managing and/or controlling of a business process

(76) Inventor: Gerhard Buchholtz, Erlangen (DE)

Correspondence Address: LYON & LYON LLP, 633 WEST FIFTH STREET, SUITE 4700, LOS ANGELES, CA, 90071, US

(21) Appl. No.: 09/765,925

(22) Filed: Jan. 22, 2001

(30) Foreign Application Priority Data
Dec. 4, 2000 (DE) 100 60 177.4

(51) Int. Cl. G06F 17/60

(52) U.S. Cl. 705/80

(57) ABSTRACT

Method and data processing system for the knowledge-based advising, managing and/or controlling of a business process

The invention relates to a method and a data processing system for the knowledge-based advising, managing and/or controlling of a business process, in which at least two parties are involved. The data processing system has a means (1 to 8) assigned to each party for information processing, providing the parties with interactive access to a database (10) for the process-accompanying input and process-accompanying build-up of process knowledge and/or expert knowledge, a logical interlinking of the process knowledge and expert knowledge taking place within the database. On the basis of this interlinking, an assessment characterizing the status of the business process takes place under the control of partial results, from which assessment a course of action is generated for at least one of the parties and is automatically signaled to the party.

The invention relates to a method and a data processing system for the knowledge-based advising, managing and/or controlling of a business process, in which at least two parties are involved.

The advising of companies on complex business processes, which is also referred to as consulting, and the managing and controlling of complex business processes, for example of a product production process, also referred to as coaching and controlling, represent in practice a task which is difficult to coordinate and, on account of its complexity, is often not performed to the satisfaction of the client with regard to the advisory service, the costs to be expended on it, the sustained effect and the verifiability of the results. The success of the advising, managing and controlling function has so far been largely dependent on the individual expert knowledge and individual experience of the adviser or manager, giving rise to a not inappreciable risk for a project which is to be controlled by means of the business process.

As far as the advice is concerned, an absence of thorough expert competence on the part of advisers, for example lack of knowledge with regard to the interrelationship of requirements of the market and technical feasibility in the product production process often leads to changes of advisers, accompanied by inadequate results of advice. On account of a lack of knowledge of the process or lack of descriptions of a process, even successful advisory activities are often very costly undertakings, the reproducibility of which, or even transfer of which to other projects, succeeds only in rare cases.

At present, advice is generally given on site at the client's premises by one or more advisers. The work of the advisers is, however, rarely continuous and is often characterized by the advisers traveling frequently, for which reason the advisers are only available to a limited extent when short-term problems arise and for the direct exchange of information in a specific technical area. The result of the advice is often also difficult to gauge because of a lack of transparency.

Therefore, to sum up, it can be stated that the customer often feels inefficiently advised and perceives the results as unsatisfactory in relation to the costs for the advice.

The invention is therefore based on the object of specifying a method and designing a data processing system of the type stated at the beginning in such a way that the advising, managing and/or controlling of a business process is improved by using technical means.

According to the invention, this object is achieved by a method as claimed in claim 1 and a data processing system as claimed in claim 13. According to the invention, at least two parties are involved in the business process which is to be managed or controlled on a knowledge basis or is to be accompanied by knowledge-based advice, said parties in each case having means for information processing, providing the parties with interactive access to a database for the process-accompanying input and process-accompanying build-up of process knowledge and expert knowledge. Process knowledge is understood here as meaning knowledge directed at the execution of the business process, which forms the framework of the business process already provided with basic contents. Process knowledge of this kind concerns for example the knowledge about the preparation of documents, such as the preparation of a specification, a quality management plan or a project management plan, and also knowledge on process sequences, such as the implementation of feasibility analyses or the development of a product or its components, which is recorded in process descriptions embodying “best practice” process knowledge. This process knowledge is supplemented in the course of the business process by person-dependent and process-dependent expert knowledge. Within the database, a logical interlinking of the process knowledge and expert knowledge takes place, an assessment characterizing the status of the business process or an assessment characterizing the status of subprocesses of the business process taking place on the basis of this interlinking, preferably interactively and under the control of partial results, from which assessment a course of action is generated for at least one of the parties and is signaled to the party, preferably automatically. Accordingly, an adviser and organizational units of a company simultaneously have access to a database into which expert knowledge, which in the future may also become process knowledge, can be entered in the manner of a process-accompanying function. The parties can exchange information concerning the business process directly with one another via the database in such a way that, for example, the adviser can assess the status of the business process without having to be on site at the company premises and can signal automatically to organizational units of the company actions to be taken on the basis of the status of the process. The automatic signaling draws the attention of an affected party immediately to the required course of action in an advantageous way, so that the preconditions for a rapid advancement of the business process are created. Particularly advantageous here is not only that a company can be given advice location-independently, but also that process knowledge and expert knowledge are stored continuously, so that not only is the advice reproducible but the increasing knowledge can also be used for other knowledge-based advisory activities. In addition, the adviser, and also moreover the organizational units of the company, can use the, possibly not very familiar, process knowledge and expert knowledge already recorded in the database and in this way arrive at better results of advice.

One variant of the invention provides that the interlinking of process knowledge and expert knowledge takes place on the basis of at least one table for the structured gathering of expert knowledge. In this case, the experts contribute their expert knowledge according to the requirements of the process descriptions. The gathered expert knowledge, for example proposed actions, is assessed at certain times with regard to its relevance, from which assessment further courses of action for the advancement of the business process are generated and signaled to the party respectively responsible for this, preferably automatically.

According to a further variant of the invention, the interlinking of process knowledge and expert knowledge takes place on the basis of at least one checklist, which preferably has at least one milestone-related work package, which contains subprocesses of the business process to be executed. On the basis of the checklist, an assessment of the subprocesses takes place at certain points in time, for example with regard to their execution and the consequent results, from which assessment at least one course of action is generated for at least one party and is signaled to the party, preferably automatically. The checklists serve in particular for checking the degree of readiness for implementing the content of the preset requirements of the process descriptions. The checking of the product production process is consequently knowledge-based.

The assessment of the proposals of the experts in the tables and the work packages of the checklists and also the associated signaling accordingly make the business process dynamic, by it being possible to have a direct controlling influence on the further progress of the business process.

According to one embodiment of the invention, the assessment takes place by means of numerical values or colored marking of areas. According to one variant of the invention, the signaling of the course of action is effected by automatic generation of an e-mail or the setting of a hyperlink. Depending on the assessment, one of the parties involved in the business process can consequently be informed by an e-mail whether for example a work package has not been processed, or only inadequately, or, if the work package has been successfully processed, how to proceed. If the work package has only been partially executed, the party having to process the work package can be stopped from immediately performing its tasks by the automatically generated e-mail. At the same time, an e-mail can automatically be generated to the management and other parties, signaling the hold-up in the business process on the basis of the unexecuted work package.

A particularly preferred embodiment of the invention provides that courses of action may lie in formulating, defining, supplementing or executing work packages, requirements, functions, functional descriptions, system analyses, components, process descriptions, technical features, target values, assessments, priorities, risks or actions for reducing risks.

Further embodiments of the invention provide that the process knowledge contained in the database is based on the process knowledge of a standard business process, which can be respectively adapted to a branch-specific individual process, with slight modifications, for the knowledge-based advising, managing and/or controlling function. The process knowledge of the standard business process in this case forms not only the basis for business processes in the industrial area, for example for a product production process, but also for business processes in commerce and banking, for example for a risk management process for investments and financing, or else for business processes of other branches.

According to one variant of the invention, the interactive access to the database takes place via a communication network, preferably the Internet or a company-internal intranet. The parties involved in the business process are generally the company management, project teams, suppliers, customers and/or advisers.

An exemplary embodiment of the invention is represented in the attached schematic drawings, in which:

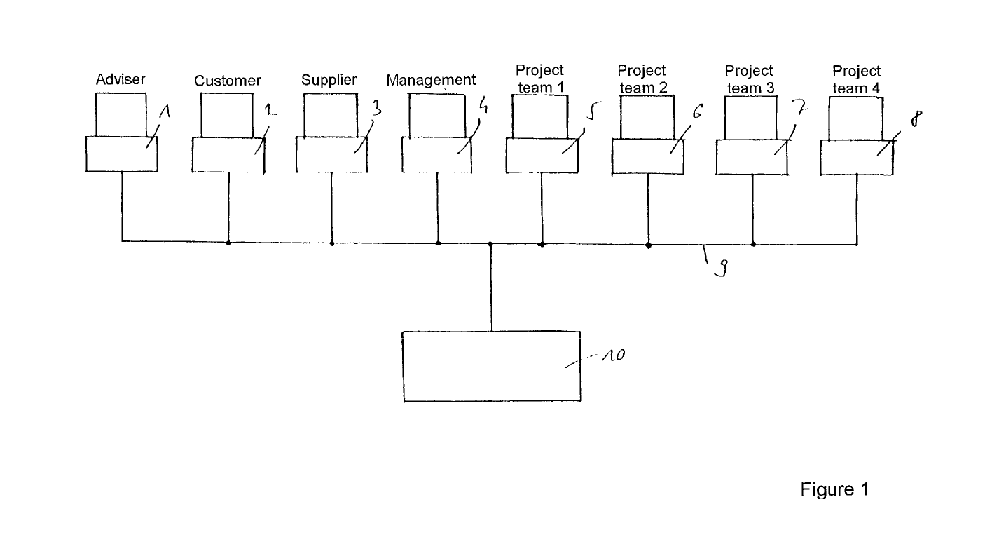

FIG. 1 shows a data processing system for executing the method for the knowledge-based advising, managing and controlling of a business process,

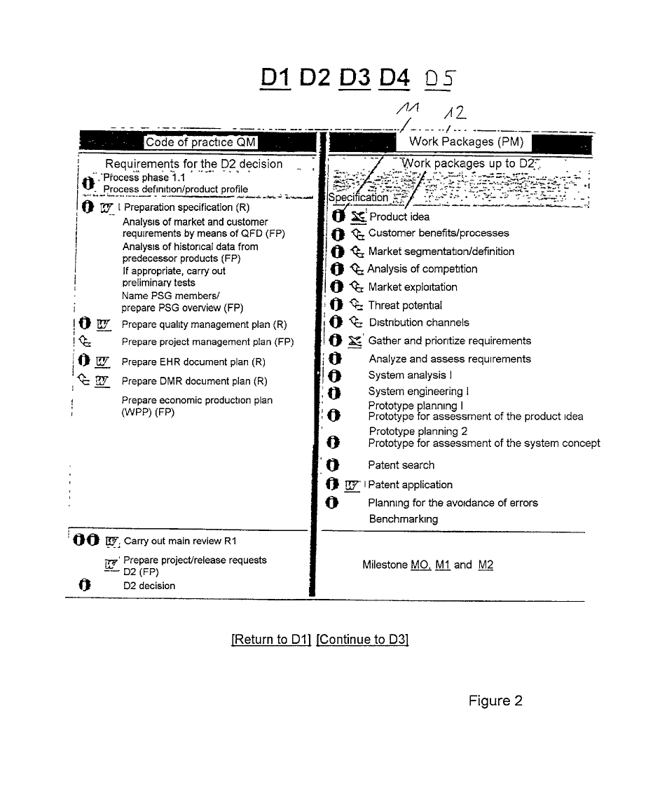

FIG. 2 shows the process knowledge of a stage D2 of a product production process, summarized in codes of practice and work packages,

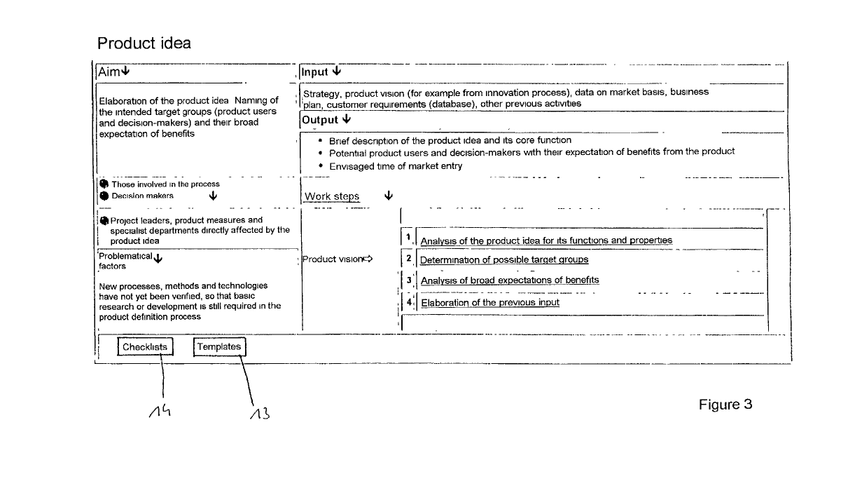

FIG. 3 shows an information page for a “product idea” work package,

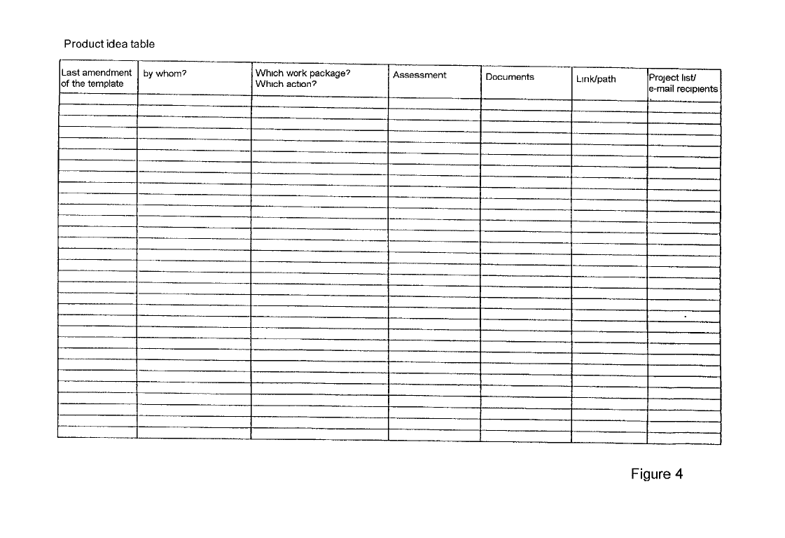

FIG. 4 shows a table for the structured gathering of expert knowledge, and

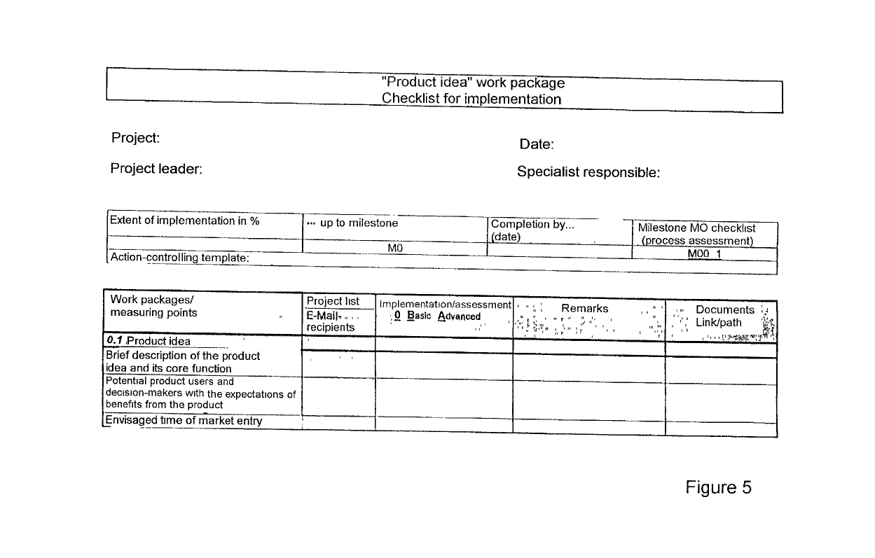

FIG. 5 shows a checklist for the “product idea” work package for the assessment of partial results.

The invention is illustrated below by way of example on the basis of a product production process.

FIG. 1 shows a data processing system, which has means for information processing in the form of personal computers PCs 1 to 8. Each of the PCs 1 to 8 is assigned to an organizational unit or party involved in the product production process. In the case of the present exemplary embodiment, the parties involved in the product production process comprise an adviser for consulting tasks, the customer, a supplier, the management of a company whose product production process is to undergo accompanying functions, and project teams 1 to 4 of the company. The PCs 1 to 8 assigned to the parties, which are generally separated spatially and locationally from one another, are connected to one another via a communication network 9, for example a company-internal intranet or via the Internet, so that communication between the parties is possible by means of the PCs 1 to 8. Furthermore, a database 10, to which the parties have interactive access, is connected to the communication network 9.

The database 10 includes a so-called management tool for the knowledge-based advising, managing or controlling of the product production process. The basis for the product production process is a standard business process, in which branch-independent process knowledge and branch-independent procedures for the execution of business processes are contained. Process knowledge for a product production process can be generated from the process knowledge of the standard business process by simple branch-specific adaptations, in that the process knowledge of the standard business process is supplemented by the process steps typical for the respective product production process or in that the process steps of the standard business process are correspondingly modified. It goes without saying that the standard product production process can also be generated, then just having to be adapted product-specifically for the respective application.

In the case of the present exemplary embodiment, the product production process essentially comprises three business processes, which are not explicitly presented in all their details, a product definition process, a product development process and a product backup process, which are divided into stages D1 to D5. In stages D1 and D2, the product strategy and product profile are for example prepared as part of the product definition. All five stages D1 to D5 of the product production process include a so-called code of practice and work packages to be executed within the stage, which are contained in the database 10.

The code of practice and the work packages form the framework of the product production process and include “best practice” process knowledge on the procedures within the product production process, embodied in process descriptions. FIG. 2 shows by way of example an extract from the code of practice and the work packages of stage D2 of the product production process, which can be called up from the database 10 from any of the PCs 1 to 8 and displayed on the monitors assigned to the PCs 1 to 8. In the case of the present exemplary embodiment, there exist in relation to the individual requirements of the code of practice and in relation to the work packages items of information identified by “i” 11, which can be called up from the database 10 from the PCs 1 to 8, describe the respective requirement or the respective work package in more detail and provide assistance for the processing thereof.

FIG. 3 shows by way of example for such an item of information the information page which is present in the database 10 for the “product idea” work package 12 of stage D2 of the product production process. If, for example, the project team 1 is responsible for the processing of the “product idea” work package 12, the project team 1 can be guided in the processing of the work package by the process knowledge summarized on the information page in process descriptions, which provide information on, inter alia, the objectives, participation in the process and, in particular, on the work steps to be executed.

This process knowledge represents a type of static component of the product production process. This static component is then supplemented in the course of the product production process by a kind of dynamic component, namely the expert knowledge possessed by the parties involved in the product production process. As can be seen from FIG. 3, the information page of the “product idea” work package, and moreover preferably all information pages of work packages of stages D1 to D5 of the product production process, has/have at least one table and/or checklist, which in the case of the present exemplary embodiment can be called up by means of a button identified by the inscription “checklists” 14, in a way known per se, for example by means of a mouse click.

While the items of information evident by way of example from FIGS. 2 and 3 contain previously known process knowledge, the table represents a medium for the structured gathering of expert knowledge which is relevant for the processing of the respective work package of the product production process, in the case of the present exemplary embodiment for the “product idea” work package. The expert knowledge accordingly supplements the known process knowledge of the product production process. A blank form of a table of this type is shown in FIG. 4. If, during the execution of the “product idea” work package by the project team 1, new findings or problems arise that are relevant to the successful and usable processing of the work package, new work packages or other actions to be taken can for example be formulated by the project team 1 on the basis of these findings or problems and be correspondingly recorded in the table. It is consequently clear that, by means of the table, existing process knowledge can be interlinked with expert knowledge, namely the expert knowledge of the project team 1, in a way which is logical and intelligible for everyone. At the same time, all the parties involved in the product production process have access to the table via the communication network 9, in order to find out about the state of the “product idea” work package and share the newly formulated expert knowledge.

This approach has considerable significance for the management of the company and, in particular, for the external adviser, since the management and the adviser, who does not have to be represented on site at the company as its customer, can find out about the status of the product production process in a simple way by means of the interactive access to the database 10. In addition, the adviser is offered the possibility of operating so-called electronic consulting (e-consulting). Similarly, the management of the company can operate a kind of electronic coaching or controlling. This is so because, according to the invention, an assessment of the work packages and actions proposed by the project team 1 can take place with regard to the successful execution of the “product idea” work package, from which assessment courses of action are generated and signaled, preferably automatically, to one of the parties of the product production process affected by the courses of action. The assessment may take place, for example, by a proposed work package or a proposed action being marked as not required, required or urgently required, which can also be achieved by numerical values 0, 1 and 2 or by colored marking of areas by green, yellow and red. The signaling to the party respectively affected may take place by manually or automatically determining the party responsible for the processing of the respective subject on the basis of the assessment of the proposed work package or the proposed action from a project list which is classified according to subjects and can be seen for example via a hyperlink, and by the party being informed of the action to be executed, or to be taken, automatically as a result of their selection, for example by means of an e-mail. The automatically generated message in the form of the email in this case automatically has the required items of information on the work package or the action added to it. Alternatively, a hyperlink may be set and transmitted to the party respectively affected, so that the party affected is referred directly, by activating of the hyperlink, to the table prepared by the project team 1, from which the party affected, for example a project team 2, receives the relevant items of information on the execution of a proposed work package or a proposed action. Furthermore, it is provided for an item of information which refers to the party responsible for the execution of the proposed work package or the proposed action, that is for example to the project team 2, to be generated automatically in the table, so that it is evident to everyone which of the parties of the product production process is responsible for the proposed work package or the proposed action.

In addition, further signals can be generated, preferably automatically, by the assessment of the adviser or management, for instance preferably all parties affected by the proposed work package or the proposed action are informed about its effects via e-mail. For example, the management can be informed about delays in the product production process or a project team 3 is notified that the beginning of the processing of a work package dependent on work and results of the project team 1 and project team 2 is being delayed or that the emphasis of the work package is being changed.

A further possible way of interlinking process knowledge and expert knowledge is offered by the checklist likewise offered on the “product idea”, information page, serving in particular for the so-called coaching and controlling of the product production process. FIG. 5 represents by way of example a checklist of this type for the milestone-related “product idea” work package. The checklist has the subprocesses to be executed of the “product idea” work package for the product production process. Each of these subprocesses is assessed for example by the adviser or the management with respect to its status or with respect to its result on the basis of the documents prepared. The assessment takes place in a way analogous to that in the case of the table by means of numbers 0, 1 and 2, by means of colored marking in red, yellow and green or, as indicated in FIG. 5, by “0”, “basic” and “advanced”. On the basis of the assessment, at least one course of action is in turn generated manually or else automatically, the party responsible for processing is determined manually or automatically from a project list which is classified according to subjects and can be seen for example via a hyperlink, and the course of action is signaled, preferably automatically, by selection of the party affected. If, for example, it is found that a brief description of the product idea and its core function has not taken place as yet, the assessment “0” is awarded, whereby an e-mail is automatically sent for example to the project team 1, with the request to compose a brief description of this type. If it is found that the brief description is still not adequate and needs to be supplemented, the assessment “basic” is for example awarded, whereby an e-mail to the project team 1 is generated, with the message that the brief description still has deficiencies. In what way the deficiencies can be rectified can be taken for example from the remarks column, which serves for the entry of expert knowledge. If, on the other hand, it is found that the brief description meets the requirements, the assessment “advanced” may be awarded, from which assessment for example an e-mail is sent to the project team 4, disclosing that, for example, a work package which requires the brief description of the product idea and its core function and is to be processed by the project team 4 can be started. In a comparable way, suppliers and customers can also be brought into the product production process, in that, on the basis of an assessment in a table or checklist, a supplier is awarded a contract, for example by e-mail, for the delivery of parts for the product development in stage D4 of the product production process or in that a customer is asked by e-mail to issue customer requirements in the course of the product definition of stage D2 of the product production process.

It consequently becomes clear that the product production process is also made dynamic by means of checklists, on the basis of the assessment of subprocesses and the courses of action signaled as a result to the parties affected.

It was explained above that, on the basis of the assessment of proposals and partial results, courses of action in the form of work packages are generated and signaled to the party or parties responsible for them. However, courses of action do not necessarily have to lie only in the formulation and execution of work packages. Rather, courses of action may also lie in requirements. For example, it may be signaled to a project team that it has been given the task of defining product-specific requirements, to be listed for example as customer wishes or technical requirements for a product, and of allocating requirement numbers, so-called requirement keys, for a unique assignment of the requirements. The requirements, that is their assessment, may give rise to courses of action for another project team or be signaled automatically to the latter in such a way that functions, that is technical solutions achieving the requirements, which are to be described and to which unique function numbers are to be assigned are to be defined or devised. On the basis of the functions and the assessment, courses of action for further project teams can then arise in the form of prioritizing of the functions and a system analysis, the assessment of which in turn signals to another party of the product production process the task of a risk analysis for the selected product concept.

Further courses of action signaled to a party of the product production process, based on the degree of readiness of subprocesses, on deadlines, on the assessment of the process quality or other preset requirements, may lie in the definition of technical features, in the selection of components, in the description of processes, in the fixing of target values, in the assessment itself or in the definition of actions for reducing risks. This enumeration is to be understood only by way of example and not as exhaustive.

It consequently becomes clear that the method according to the invention for generating courses of action and preferably automatic signaling of the courses of action to the parties affected makes the product production process dynamic, in that not only a continuous progression of the product production process is ensured but also existing process knowledge is constantly supplemented by expert knowledge.

The advantages of this procedure are that process knowledge is supplemented by expert knowledge, which ultimately leads to the already known process knowledge being perfected, whereby a broader knowledge base is increasingly created for the product production process. Process knowledge and expert knowledge in is this case represent the product knowledge. Further advantages of the invention lie in the linking up of an interdisciplinary team, in the support of cooperative working and in the purposeful exchange of information between advisers, customers, suppliers, management and project teams of a company.

In addition, the continuous gathering of process knowledge and expert knowledge has the effect that the knowledge can be reused for comparable business processes, based on the database of experience and knowledge. The consulting activity can also becomes intelligible and reproducible. In particular, an increase in the efficiency of the advising on projects is obtained with regard to quality, costs, deadlines and sustained effect.

The invention was described above on the basis of the example of a product production process. However, application of the invention is not restricted to a product production process, it can instead be used in the case of other business processes, for example in 35 commerce and banking for risk analyses.

The structure of the tables and checklists for the interlinking of process knowledge and expert knowledge is to be understood as being only by way of example. The tables and checklists may also be designed differently.

In addition, the interlinking of process knowledge and expert knowledge does not necessarily have to take place by means of tables and checklists, but may also take place by other means.

Depending on the business process, only tables or only checklists may also be used for the interlinking of process knowledge and expert knowledge.

1. A method for the knowledge-based advising, managing and/or controlling of a business process, in which at least two parties are involved, which parties in each case have means (1 to 8) for information processing, providing the parties with interactive access to a database (10) for the process-accompanying input and process-accompanying build-up of process knowledge and/or expert knowledge, a logical interlinking of the process knowledge and expert knowledge taking place within the database (10), and an assessment characterizing the status of the business process taking place on the basis of this interlinking under the control of partial results, from which assessment a course of action is generated for at least one of the parties and is signaled to the party.

2. The method as claimed in claim 1, in which the interlinking of process knowledge and expert knowledge takes place on the basis of at least one table for the structured gathering of expert knowledge.

3. The method as claimed in claim 1 or 2, in which the interlinking of process knowledge and expert knowledge takes place on the basis of at least one checklist.

4. The method as claimed in claim 3, in which the checklist has at least one milestone-related work package, which contains subprocesses of the business process to be executed.

5. The method as claimed in one of claims 1 to 4, in which the assessment takes place by means of numerical values or colored marking of areas.

6. The method as claimed in one of claims 1 to 5, in which the signaling of the direction for action takes place by automatic generation of an e-mail or the setting of a hyperlink.

7. The method as claimed in one of claims 1 to 6, in which the course of action lies in formulating, defining, supplementing or executing work packages, requirements, functions, functional descriptions, system analyses, components, process descriptions, technical features, target values, assessments, priorities, risks or actions for reducing risks.

8. The method as claimed in one of claims 1 to 7, in which the process knowledge contained in the database (10) is based on the process knowledge of a standard business process which can be adapted to a branch-specific individual process for the knowledge-based advising, managing and/or controlling function.

9. The method as claimed in one of claims 1 to 8, in which the business process is a product production process.

10. The method as claimed in one of claims 1 to 9, in which the interactive access to the database (10) takes place via a communication network (9).

11. The method as claimed in claim 10, in which the communication network (9) is the Internet or a company-internal intranet.

12. The method as claimed in one of claims 1 to 11, in which the parties involved in the business process comprise the company management, project teams, suppliers, customers and/or advisers.

13. A data processing system for the knowledge-based advising, managing and/or controlling of a business process, in which at least two parties are involved, having means (1 to 8) for information processing, providing the parties with interactive access to a database (10) for the process-accompanying input and process-accompanying build-up of process knowledge and expert knowledge, and means for the logical interlinking of the process knowledge and expert knowledge within the database, and an assessment characterizing the status of the business process taking place on the basis of this interlinking under the control of partial results, from which assessment a course of action is generated for at least one of the parties and is signaled to the party.

14. The data processing system as claimed in claim 13, in which the interlinking of process knowledge and expert knowledge takes place on the basis of at least one table for the structured gathering of expert knowledge.

15. The data processing system as claimed in either of claims 13 and 14, in which the interlinking of process knowledge and expert knowledge takes place on the basis of at least one checklist.

16. The data processing system as claimed in claim 15, in which the checklist has at least one milestone-related work package, which contains subprocesses of the business process to be executed.

17. The data processing system as claimed in one of claims 13 to 16, in which the assessment takes place by means of numerical values or colored marking of areas.

18. The data processing system as claimed in one of claims 13 to 17, in which the signaling of the direction for action takes place by automatic generation of an e-mail or the setting of a hyperlink.

19. The data processing system as claimed in one of claims 13 to 18, in which the course of action lies in formulating, defining, supplementing or executing work packages, requirements, functions, functional descriptions, system analyses, components, process descriptions, technical features, target values, assessments, priorities, risks or actions for reducing risks.

20. The data processing system as claimed in one of claims 13 to 19, in which the process knowledge contained in the database (10) is based on the process knowledge of a standard business process which can be adapted to a branch-specific individual process for the knowledge-based advising, managing and/or controlling function.

21. The data processing system as claimed in one of claims 13 to 20, in which the business process is a product production process.

22. The data processing system as claimed in one of claims 13 to 21, in which the interactive access to the database (10) takes place via a communication network (9).

23. The data processing system as claimed in claim 22, in which the communication network (9) is the Internet or a company-internal intranet.

24. The data processing system as claimed in one of claims 13 to 23, in which the parties involved in the business process comprise the company management, project teams, suppliers, customers and/or advisers.
